(19) United States
(12) Patent Application Publication
(10) Pub. No.: US 2018/0112063 A1
(43) Pub. Date: Apr. 26, 2018

(54) HIGH DENSITY POLYETHYLENE COMPOSITIONS HAVING IMPROVED LOW TEMPERATURE IMPACT PROPERTIES AND ARTICLES MADE THEREFROM

(71) Applicant: EQUISTAR CHEMICALS, LP, HOUSTON, TX (US)

(72) Inventors: LINDSAY E. CORCORAN, LIBERTY TOWNSHIP, OH (US); JEFFREY S. BORKE, LIBERTY TOWNSHIP, OH (US)

(73) Assignee: EQUISTAR CHEMICALS, LP, HOUSTON, TX (US)

(21) Appl. No.: 15/791,581

(22) Filed: Oct. 24, 2017

Related U.S. Application Data
(60) Provisional application No. 62/412,475, filed on Oct. 25, 2016.

(51) Int. Cl. C08K 5/17; C08K 5/098

(52) U.S. Cl. CPC C08K 5/175; C08K 5/098

(57) ABSTRACT

The present disclosure provides a polyolefin-based composition made from or containing: (A) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius, and (B) a first nucleator composition made from or containing a salt of 4-(4-chlorobenzoylamino) benzoate. The polyolefin-based composition is useful for making articles of manufacture for rigid applications, including low temperature, thin-walled applications.

### CROSS-REFERENCE TO RELATED APPLICATIONS

This application is the Non-Provisional Patent Application, which claims benefit of priority to U.S. Provisional Application No. 62/412,475, filed Oct. 25, 2016, the contents of which are incorporated herein by reference in their entirety.

### FIELD OF THE INVENTION

In general, the present disclosure relates to the field of chemistry. More specifically, the present disclosure relates to polymer chemistry. In particular, the high density polyethylene compositions are useful in low temperature applications.

### BACKGROUND OF THE INVENTION

Low temperature impact is an important property for many rigid applications. Examples of such applications are appliances, automotive products, consumer products, housewares, industrial containers, packaging, sporting goods, toys, and novelties.

It is desirable to provide high density polyethylene-based compositions that impart suitable low temperature impact properties to articles for use in those applications. It is also desirable that these articles demonstrate low temperature impact properties even when the articles have a thin-wall. It is further desirable that high density polyethylene-based composition be processable by injection molding.

### BRIEF SUMMARY OF THE INVENTION

In general embodiments, the present disclosure provides a polyolefin-based composition made from or containing:
(A) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius and
(B) a first nucleator composition made from or containing a salt of 4-(4-chlorobenzoylamino) benzoate.

In some embodiments, the present disclosure provides an article of manufacture made from or containing:
(A) a polyolefin-based composition made from or containing:
   (i) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius and
   (ii) a first nucleator composition made from or containing a salt of 4-(4-chlorobenzoylamino) benzoate.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE SEVERAL VIEWS OF THE DRAWINGS

The following figures illustrate preferred embodiments of the subject matter disclosed herein. The claimed subject matter may be understood by reference to the following description taken in conjunction with the accompanying figures, in which like reference numerals identify like elements, and in which:

FIG. 1A provides a cross-polarized light image obtained using a scanning electron microscope from a plaque's surface, wherein the plaque had a thickness of 125 mils (3.175 mm) and was prepared from a high density polyethylene suitable for use in the present invention, in the absence of a nucleator composition. FIG. 1B provides a cross-polarized light image from a plaque's surface, wherein the 125-mil thick plaque was prepared from a polymeric composition made from or containing (a) a high density polyethylene suitable for use in the present invention, (b) a nucleator composition suitable for use in the present invention in an amount of about 1000 ppm based upon the weight of the total polymeric composition, and (c) an acid scavenger suitable for use in the present invention. FIG. 1C provides a cross-polarized light image from a plaque's surface, wherein the 125-mil thick plaque was prepared from a polymeric composition made from or containing (a) a high density polyethylene suitable for use in the present invention, (b) a nucleator composition suitable for use in the present invention in an amount of about 2000 ppm based upon the weight of the total polymeric composition, and (c) an acid scavenger suitable for use in the present invention.

FIG. 2A provides a cross-polarized light image from a plaque's surface, wherein the plaque had a thickness of 40 mils (1.016 mm) and was prepared from a high density polyethylene suitable for use in the present invention, in the absence of a nucleator composition. FIG. 2B provides a cross-polarized light image from a plaque's surface, wherein the 40-mil thick plaque was prepared from a polymeric composition made from or containing (a) a high density polyethylene suitable for use in the present invention, (b) a nucleator composition suitable for use in the present invention in an amount of about 1000 ppm based upon the weight of the total polymeric composition, and (c) an acid scavenger suitable for use in the present invention. FIG. 2C provides a cross-polarized light image from a plaque's surface, wherein the 40-mil thick plaque was prepared from a polymeric composition made from or containing (a) a high density polyethylene suitable for use in the present invention, (b) a nucleator composition suitable for use in the present invention in an amount of about 2000 ppm based upon the weight of the total polymeric composition, and (c) an acid scavenger suitable for use in the present invention.

FIG. 3A provides a cross-polarized light image from a plaque's core, wherein the plaque had a thickness of 125 mils (3.175 mm) and was prepared from a high density polyethylene suitable for use in the present invention, in the absence of a nucleator composition. FIG. 3B provides a cross-polarized light image from a plaque's core, wherein the 125-mil thick plaque was prepared from a polymeric composition made from or containing (a) a high density polyethylene suitable for use in the present invention, (b) a nucleator composition suitable for use in the present invention in an amount of about 1000 ppm based upon the weight of the total polymeric composition, and (c) an acid scavenger suitable for use in the present invention. FIG. 3C provides a cross-polarized light image from a plaque's core, wherein the 125-mil thick plaque was prepared from a polymeric composition made from or containing (a) a high density polyethylene suitable for use in the present invention, (b) a nucleator composition suitable for use in the present invention in an amount of about 2000 ppm based upon the weight of the total polymeric composition, and (c) an acid scavenger suitable for use in the present invention.

FIG. 4A provides a cross-polarized light image from a plaque's core, wherein the plaque had a thickness of 40 mils (1.016 mm) and was prepared from a high density polyethylene suitable for use in the present invention, in the absence of a nucleator composition. FIG. 4B provides a cross-polarized light image from a plaque's core, wherein the 40-mil thick plaque was prepared from a polymeric composition made from or containing (a) a high density polyethylene suitable for use in the present invention, (b) a nucleator composition suitable for use in the present invention in an amount of about 1000 ppm based upon the weight of the total polymeric composition, and (c) an acid scavenger suitable for use in the present invention. FIG. 4C provides a cross-polarized light image from a plaque's core, wherein the 40-mil thick plaque was prepared from a polymeric composition made from or containing (a) a high density polyethylene suitable for use in the present invention, (b) a nucleator composition suitable for use in the present invention in an amount of about 2000 ppm based upon the weight of the total polymeric composition, and (c) an acid scavenger suitable for use in the present invention.

### DETAILED DESCRIPTION OF THE INVENTION

The present invention now will be described more fully hereinafter. However, this invention can be embodied in many different forms and should not be construed as limited to the embodiments set forth herein; rather, these embodiments are provided so that this disclosure will satisfy applicable legal requirements. As such, it will be apparent to those skilled in the art that the embodiments can incorporate changes and modifications without departing from the general scope. It is intended to include all the modifications and alterations in so far as the modifications and alterations come within the scope of the appended claims or the equivalents thereof.

As used in this specification and the claims, the singular forms “a,” “an,” and “the” include plural referents unless the context clearly dictates otherwise.

As used in this specification and the claims, the terms “comprising,” “containing,” or “including” mean that at least the named compound, element, material, particle, or method step, etc., is present in the composition, the article, or the method, but does not exclude the presence of other compounds, elements, materials, particles, or method steps, etc., even if the other such compounds, elements, materials, particles, or method steps, etc., have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is a means for identifying discrete activities or ingredients and the recited lettering can be arranged in any sequence, unless expressly indicated.

For the purpose of the present description and of the claims which follow, except where otherwise indicated, numbers expressing amounts, quantities, percentages, and so forth, are to be understood as being modified by the term “about”. Also, ranges include any combination of the maximum and minimum points disclosed and include any intermediate ranges therein, which may or may not be specifically enumerated herein.

### Definitions

In the present description, the term “additives composition” refers to a composition made from or containing at least one additive.

In the present description, the term “crystallization half time” or “t_{1/2}” refers to the time at which the extent of crystallization is 50% completed at 119 degrees Celsius and measured according to ASTM D 3418. The shorter the half-time means the faster the crystallization rate.

In the present description, the term “first” refers to the order in which a particular species is presented and does not necessarily indicate that a “second” species will be presented. For example, “first polymer composition” refers to the first of at least one polymer composition. The term does not reflect priority, importance, or significance in any other way. Similar terms used that can be used herein include “second,” “third,” “fourth,” etc.

In the present description, the term “long chain branch index (LCBI)” refers to a measurement of the concentration of long chain branches in a polyolefin. LCBI is a rheological index used to characterize low levels of long-chain branching. LCBI is defined as:

$$LCBI = \frac{{η}_{0}^{0.179}}{4.8 - [ η ]} - 1$$

where η₀ is the limiting, zero-shear viscosity (Poise) at 190 degrees Celsius and [η] is the intrinsic viscosity in trichlorobenzene at 135 degrees Celsius (dL/g). LCBI is based on observations that low levels of long-chain branching, in an otherwise linear polymer, result in a large increase in melt viscosity, η₀, with no change in intrinsic viscosity, [η]. See R. N. Shroff and H. Mavridis, “Long-Chain-Branching Index for Essentially Linear Polyethylenes,” Macromolecules, Vol. 32 (25), pp. 8454-8464 (1999). Higher LCBI means a greater number of long-chain branches per polymer chain.

In the present description, the term “low temperature” means less than or equal to about 0 degrees Celsius. For certain applications, the desired low temperature performance should be achieved at a temperature less than or equal to −40 degrees Celsius.

In the present description, the term “melt flow ratio (MFR)” means the ratio of the high load melt index (or HLMI) to the standard melt index. The standard melt index values of polyethylene polymers are measured according to ASTM D 1238, using a piston load of 2.16 kg and at a temperature of 190 degrees Celsius. The HLMI values are also measured according to ASTM D 1238 at a temperature of 190 degrees Celsius but using a piston load of 21.6 kg.

In the present description, the term “nucleator composition” refers to a composition made from or containing at least one nucleator.

In the present description, the term “polymer” means a macromolecular compound prepared by polymerizing monomers of the same or different type. The term “polymer” includes homopolymers, copolymers, terpolymers, interpolymers, and so on.

In the present description, the term “polymer composition” refers to a composition made from or containing at least one polymer.

In the present description, the term “polyolefin” is used herein broadly to include polymers such as polyethylene, ethylene-alpha olefin copolymers (EAO), polypropylene, polybutene, and ethylene copolymers having at least about 50 percent by weight of ethylene polymerized with a lesser amount of a comonomer such as vinyl acetate, and other polymeric resins within the “olefin” family classification.

Polyolefins can be made by a variety of processes including batch and continuous processes using single, staged, or sequential reactors, slurry, solution, and fluidized bed processes and one or more catalysts including for example, heterogeneous and homogeneous systems and Ziegler, Phillips, metallocene, single-site, and constrained geometry catalysts to produce polymers having different combinations of properties.

In the present description, the term “substantially linear” refers to a polyolefin that is essentially free of long chain branching and relatively narrow in molecular weight distribution. Long chain branching can be measured by NMR, 3D-GPC, and rheology. While NMR directly measures the number of branches, it cannot differentiate between branches which are six carbons or longer. 3D-GPC with intrinsic viscosity and light scattering detection can account for all branches that substantially increase mass at a given radius of gyration. Rheology is particularly suitable for detecting low level of long chain branches.

In the present description, the term “substantially linear HDPE” refers to a high density polyethylene that is essentially free of long chain branching and relatively narrow in molecular weight distribution.

In the present description, the term “thermoplastic polymer” means a polymer that softens when exposed to heat and returns to its original condition when cooled to room temperature.

Testing

ASTM D 792 is entitled “Test Methods for Density and Specific Gravity (Relative Density) of Plastics by Displacement.” The term “ASTM D 792” as used herein refers to the standard test method for determining the specific gravity (relative density) and density of solid plastics in forms such as sheets, rods, tubes, or molded items. The test method includes determining the mass of a specimen of the solid plastic in air, determining the apparent mass of the specimen upon immersion in a liquid, and calculating the specimen's specific gravity (relative density). This test method was approved on Jun. 15, 2008 and published July 2008, the contents of which are incorporated herein by reference in its entirety.

ASTM D 1238 is entitled “Test Method for Melt Flow Rates of Thermoplastics by Extrusion Plastometer.” The term “ASTM D 1238” as used herein refers to a test method covering the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety.

Throughout the present description and claims, the standard melt index values of polyethylene polymers are measured according to ASTM D 1238, using a piston load of 2.16 kg and at a temperature of 190 degrees Celsius. The High Load Melt Index (or HLMI) values are also measured according to ASTM D 1238 at a temperature of 190 degrees Celsius but using a piston load of 21.6 kg.

Throughout the present description and claims, the standard melt flow rate values of polypropylene polymers are measured according to ASTM D 1238, using a piston load of 2.16 kg and at a temperature of 230 degrees Celsius.

ASTM D 1505 is entitled “Standard Test Method for Density of Plastics by the Density-Gradient Technique.” The term “ASTM D 1505” as used herein refers to a test method based on observing the level to which a test specimen sinks in a liquid column exhibiting a density gradient, in comparison with standards of known density. This test method was approved on Jul. 1, 2010 and published September 2010, the contents of which are incorporated herein by reference in its entirety.

ASTM D 3418 is entitled “Standard Test Method for Transition Temperatures and Enthalpies of Fusion and Crystallization of Polymers by Differenial Scanning calorimetry.” The term “ASTM D3418” as used herein refers to determination of transition temperatures and enthalpies of fusion and crystallization of polymers by differential scanning calorimetry and applies to polymers in granular form or to any fabricated shape from which it is possible to cut appropriate specimens. This test method was approved in 2015, the contents of which are incorporated herein by reference in its entirety.

ASTM D 3763 is entitled “Standard Test Method for High Speed Puncture Properties of Plastics Using Load and Displacement Sensors.” The term “ASTM D 3763” or “Instrumented Dart Impact Test” as used herein refers to the test method covers the determination of puncture properties of rigid plastics over a range of test velocities. This test method is designed to provide load versus deformation response of plastics under essentially multiaxial deformation conditions at impact velocities. This test method further provides a measure of the rate sensitivity of the material to impact. This test method was approved on Jul. 1, 2010 and published July 2010, the contents of which are incorporated herein by reference in its entirety.

For the referenced ASTM standards, visit the ASTM website, www.astm.org, or contact ASTM Customer Service at service@astm.org.

“Molecular Weight Distribution (Mw/Mn)” is measured by gel permeation chromatography. MWD and the ratio M_{w}/Mₙ are determined using a Waters 150-C ALC/Gel Permeation Chromatography (GPC) system equipped with a TSK column set (type GMHXL-HT) working at 135 degrees Celsius with 1,2-dichlorobenzene as solvent (ODCB) (stabilized with 0.1 volume of 2,6-di-t-butyl p-cresole (BHT)) at flow rate of 1 ml/min. The sample is dissolved in ODCB by stirring continuously at a temperature of 140 degrees Celsius for 1 hour. The solution is filtered through a 0.45 μm Teflon membrane. The filtrate (concentration 0.08-1.2 g/l injection volume 300 μl) is subjected to GPC. Monodisperse fractions of polystyrene (provided by Polymer Laboratories) are used as standard.

In general embodiments, the present disclosure provides a polyolefin-based composition made from or containing:
(A) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius and
(B) a first nucleator composition made from or containing a salt of 4-(4-chlorobenzoylamino) benzoate.

The First Polymer Composition: High Density Polyethylene (HDPE)

In an embodiment, the first polymer composition is present in an amount greater than about 95.0 percent, relative to the total weight of the polyolefin-based composition. The first polymer composition can be present in an amount from about 95 to about 99.9 weight percent. In some embodiments, the first polymer composition is present in 95, 96, 97, 98, 99, 99.5, 99.7, 99.8, 99.9, or an intermediate weight percent, relative to the total weight of the polyolefin-based composition.

The high density polyethylene for use in making the first polymer composition can be prepared by any method known in the art, including batch and continuous processes using single, staged, or sequential reactors, slurry, solution, and fluidized bed processes. In some embodiments, the high density polyethylene is prepared by a solution process.

In some embodiments, the high density polyethylene has a density greater than about 0.940 grams per cubic centimeter. In other embodiments, the high density polyethylene has a density in the range of about 0.940 grams per cubic centimeter to about 0.965 grams per cubic centimeter. In other embodiments, the density is 0.940, 0.945, 0.950, 0.955, 0.960, 0.965, or an intermediate density.

In some embodiments, the high density polyethylene has a melt index greater than about 4 grams per 10 minutes, measured according to ASTM D 1238, using a piston load of 2.16 kg and at a temperature of 190 degrees Celsius. In other embodiments, the high density polyethylene has a melt index greater than or equal to about 20 grams per 10 minutes. In other embodiments, the high density polyethylene has a melt index in the range of about 20 to about 65 grams per 10 minutes. In other embodiments, the melt index is 20, 25, 30, 35, 40, 45, 50, 55, 60, 65, or an intermediate melt index.

In some embodiments, the high density polyethylene has a crystallization temperature in the range of about 110 degrees Celsius to about 115 degrees Celsius. In other embodiments, the crystallization temperature is 110, 111, 112, 113, 114, 115, or an intermediate crystallization temperature.

In some embodiments, the high density polyethylene is a substantially linear high density polyethylene having a long chain branching index (LCBI) less than or equal to about 0.5. In other embodiments, the LCBI is less than or equal to about 0.3. In other embodiments, the LCBI is less than or equal to about 0.2.

In some embodiments, the high density polyethylene is a substantially linear high density polyethylene having a melt flow ratio (MFR) less than or equal to about 65. In other embodiments, the MFR is less than or equal to about 40. In other embodiments, the MFR is less than or equal to about 20.

In some embodiments, the high density polyethylene has a crystallization half time greater than or equal to about 3.0 minutes, measured at 119 degrees Celsius and according to ASTM D3418. In other embodiments, the high density polyethylene has a crystallization half time in the range of about 3.0 minutes to about 10.0 minutes. In other embodiments, the crystallization half time is 3.0, 4.0, 5.0, 6.0, 7.0, 8.0, 9.0, 10.0 minutes, or an intermediate crystallization half time.

The First Nucleator Composition: Salt of 4-(4-Chlorobenzoylamino) Benzoate

In an embodiment, the first nucleator composition is present in an amount from about 500 ppm to about 3000 ppm, relative to the total weight of the polyolefin-based composition. In some embodiments, the first nucleator composition is present in an amount from about 1000 ppm to about 2000 ppm. In other embodiments, the first nucleator composition is present in an amount of 1000, 1100, 1200, 1300, 1400, 1500, 1600, 1700, 1800, 1900, 2000, or an intermediate amount, relative to the total weight of the polyolefin-based composition.

In some embodiments, the salt of 4-(4-chlorobenzoylamino) benzoate is a sodium salt, or sodium 4-(4-chlorobenzoylamino) benzoate.

A First Additive Composition: Acid Scavenger

In some embodiments, the polyolefin-based composition further be made with or contain:
(C) a first additive composition comprising an acid scavenger.

In some embodiments, the acid scavenger is present in an amount from about 500 ppm to about 3000 ppm, relative to the total weight of the polyolefin-based composition. In some embodiments, the acid scavenger is present in an amount from about 1000 ppm to about 2000 ppm. In other embodiments, the acid scavenger is present in an amount of 1000, 1100, 1200, 1300, 1400, 1500, 1600, 1700, 1800, 1900, 2000, or an intermediate amount, relative to the total weight of the polyolefin-based composition.

In some embodiments, the acid scavenger is selected from the group consisting of calcium stearate, zinc stearate, other stearate-containing compounds, and non-ionic acid neutralizers. In some embodiments, the acid scavenger is zinc stearate. In some embodiments, the non-ionic acid neutralizer is magnesium aluminium hydroxide carbonate (hydrate), or DHT-4A.

A Second or Alternative Additives Composition

In some embodiments, the polyolefin-based composition can include an additives composition made from or containing one or more additives. This additives composition may be (a) in addition to the previously-described, optional first additive composition or (b) solely added. Examples of additives are thermal stabilizers, colorants, flame retardants, fillers, reinforcements, antistatic agents, lubricants, antioxidants, process stabilizers, ultraviolet light stabilizers, clarifiers, and the like.

Article of Manufacture

In particular embodiments, the present disclosure provides an article of manufacture made from or containing:
(A) a polyolefin-based composition made from or containing:
   (i) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius and
   (ii) a first nucleator composition made from or containing a salt of 4-(4-chlorobenzoylamino) benzoate.

Thin-Walled Articles

In some embodiments, the article of manufacture has a wall thickness less than or equal to about 125 mils (3.175 mm). In other embodiments, the article has a wall thickness less than or equal to about 80 mils (2.032 mm). In other embodiments, the article has a wall thickness is the range from about 40 mils (1.016 mm) to 80 mils (2.032 mm). In other embodiments, the article has a wall thickness that is 40, 45, 50, 55, 60, 65, 70, 75, and 80 mils (1.016, 1.143, 1.27, 1.397, 1.524, 1.651, 1.778, 1.905, and 2.032 mm, respectively), or an intermediate wall thickness.

In some embodiments, the article has a wall thickness of about 80 mils (2.032 mm) and low temperature brittle failures of less than or equal to about 20 percent, measured according to ASTM D 3763 at a temperature of −40 degrees Celsius and a rate of 2.2 m/s.

In some embodiments, the article has a wall thickness of about 40 mils (1.016 mm) and low temperature brittle failures of less than or equal to about 60 percent, measured according to ASTM D 3763 at a temperature of −40 degrees Celsius and a rate of 2.2 m/s.

### Examples

The following examples are included to demonstrate embodiments. It should be appreciated by those of skill in the art that the techniques disclosed in the examples which follow represent techniques discovered to function well, and thus can be considered to constitute exemplary modes of practice. However, those of skill in the art should, in light of the present disclosure, appreciate that many changes can be made in the specific embodiments which are disclosed and still obtain a like or similar result without departing from the spirit and scope of this disclosure.

For the comparative examples (C. Ex. or C.E.) and the examples (Ex.) of an embodiment, various compounds were formulated to prepare test specimen. The materials were admixed in the weight percents shown in the tables. The mixtures were prepared via a pellet-pellet dry blend.

The high density polyethylenes evaluated herein include:
(a) LyondellBasell's Alathon H4250 high density polyethylene has a density of 0.942 grams per cubic centimeter, a melt index of 50 grams per 10 minutes, a crystallization temperature of 112.5 degrees Celsius, and a crystallization half time of 8.6 minutes;
(b) LyondellBasell's Alathon ETP H4262 high density polyethylene has a density of 0.942 grams per cubic centimeter, a melt index of 62 grams per 10 minutes, a crystallization temperature of 112.2 degrees Celsius, and a crystallization half time of 3.7 minutes;
(c) LyondellBasell's Alathon H4837 high density polyethylene has a density of 0.948 grams per cubic centimeter, a melt index of 40 grams per 10 minutes, and a crystallization temperature of 113.6 degrees Celsius;
(d) LyondellBasell's Alathon H5234 high density polyethylene has a density of 0.952 grams per cubic centimeter, a melt index of 34 grams per 10 minutes, and a crystallization temperature of 114.0 degrees Celsius; and
(e) LyondellBasell's Alathon H5520 high density polyethylene has a density of 0.955 grams per cubic centimeter, a melt index of 20 grams per 10 minutes, and a crystallization temperature of 115.0 degrees Celsius.

The salt of 4-(4-chlorobenzoylamino) benzoate used in the test specimen was sodium 4-(4-chlorobenzoylamino) benzoate.

An acid scavenger was used in the test specimen. It was zinc stearate.

The sodium 4-(4-chlorobenzoylamino) benzoate and the zinc stearate were admixed to the selected high density polyethylene as part of a masterbatch prepared by Ravago Manufacturing Americas, LLC, CRYSTALADD™ HM-664 nucleator masterbatch. The components of sodium 4-(4-chlorobenzoylamino) benzoate and zinc stearate were in a ratio of approximately 50:50 and provided to Ravago by Milliken Chemical under Milliken's product name Hyperform HPN-210M nucleator. Together, the sodium 4-(4-chlorobenzoylamino) benzoate and the zinc stearate made up about 4 weight percent of the masterbatch, based upon the total weight of the masterbatch. The carrier of the masterbatch was a high density polyethylene having a density of 0.950 grams per cubic centimeter and a melt index of 8.2 grams per 10 minutes.

The masterbatch was added in an amount to provide sodium 4-(4-chlorobenzoylamino) benzoate in amounts of 0 ppm, 1000 ppm, and 2000 ppm, based upon the total weight of the prepared polyolefin composition.

The test specimens were prepared as 40, 80, and 125 mil (1.016, 2.032 and 3.175 mm, respectively) thick plaques via an injection molding process.

TABLE 1
40-mil Thick Plaques

| Component | C. E. 1 | Ex. 2 | Ex. 3 | C. E. 4 | Ex. 5 | Ex. 6 | C. E. 7 | Ex. 8 |
|---|---|---|---|---|---|---|---|---|
| H4250 | 100 | 97.50 | 95.00 | | | | | |
| ETP H4262 | | | | 100 | 97.50 | 95.00 | | |
| H4837 | | | | | | | | |
| H5234 | | | | | | | 100 | 95.00 |
| H5520 | | | | | | | | |
| Nucleator¹ (ppm) | 0 | 1000 | 2000 | 0 | 1000 | 2000 | 0 | 2000 |
| % Brittle Failures | 100 | 40 | 60 | 100 | 60 | 60 | 100 | 60 |

¹The nucleator composition is given in the amount of sodium 4-(4-chlorobenzoylamino) benzoate added in ppm even though the admixture contained zinc stearate and the carrier HDPE. The balance of the composition is provided by the zinc stearate and the carrier HDPE. As an illustration, Ex. 2 was prepared with 97.50% H4250, 1000 ppm sodium 4-(4-chlorobenzoylamino) benzoate, 1000 ppm zinc stearate, and 2.3% carrier HDPE.

TABLE 2
80-mil Thick Plaques

| Component | C. Ex. 9 | Ex. 10 | Ex. 11 | C. Ex. 12 | Ex. 13 | Ex. 14 |
|---|---|---|---|---|---|---|
| H4250 | 100 | 97.50 | 95.00 | | | |
| ETP H4262 | | | | | | |
| H4837 | | | | 100 | 97.50 | 95.00 |
| H5234 | | | | | | |
| H5520 | | | | | | |
| Nucleator | 0 | 1000 | 2000 | 0 | 1000 | 2000 |
| (ppm) | | | | | | |
| % Brittle | 100 | 0 | 0 | 100 | 0 | 20 |
| Failures | | | | | | |

TABLE 3
125-mil Thick Plaques

| | C. E. | Ex. | Ex. | C. E. | Ex. | Ex. | C. E. | Ex. | C. E. | Ex. | C. E. | Ex. |
|---|---|---|---|---|---|---|---|---|---|---|---|---|
| Component | 15 | 16 | 17 | 18 | 19 | 20 | 21 | 22 | 23 | 24 | 25 | 26 |
| H4250 | 100 | 97.5 | 95.0 | | | | | | | | | |
| ETP H4262 | | | | 100 | 97.5 | 95.0 | | | | | | |
| H4837 | | | | | | | 100 | 95.0 | | | | |
| H5234 | | | | | | | | | 100 | 95.0 | | |
| H5520 | | | | | | | | | | | 100 | 95.0 |
| Nucleator | 0 | 1000 | 2000 | 0 | 1000 | 2000 | 0 | 2000 | 0 | 2000 | 0 | 2000 |
| (ppm) | | | | | | | | | | | | |
| % Brittle | 100 | 0 | 10 | 100 | 0 | 0 | 40 | 20 | 100 | 0 | 40 | 0 |
| Failures | | | | | | | | | | | | |

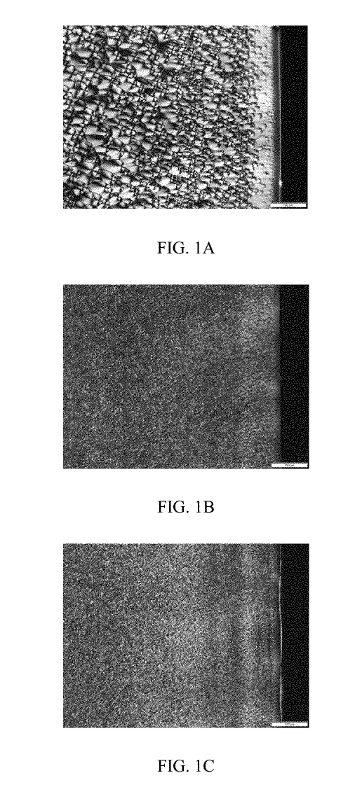

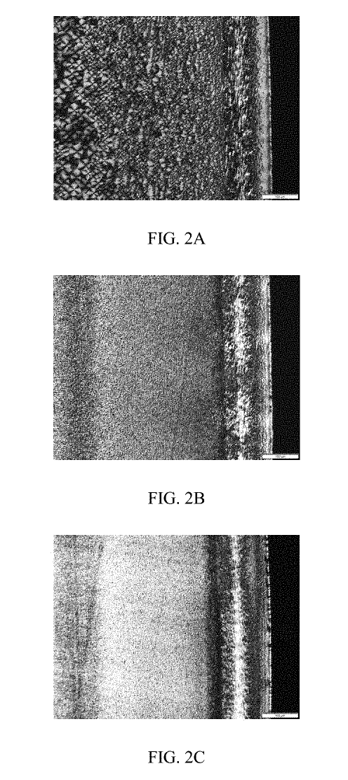

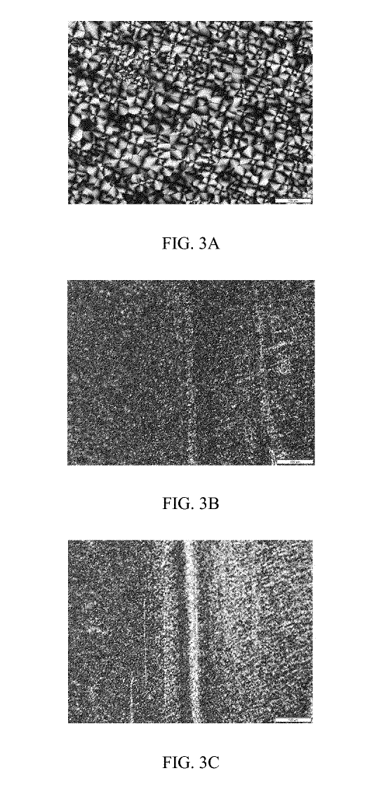

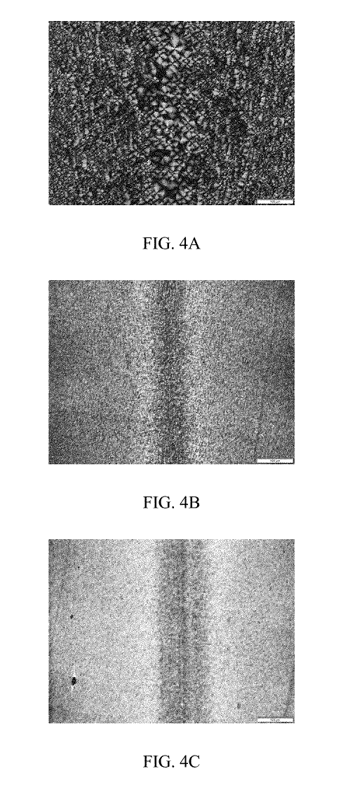

With references to FIGS. 1A-4C, the cross-polarized light images show the difference in crystallite size of nucleated compared to non-nucleated. The nucleated compositions yielded smaller crystallites and improved low temperature impact.

It should be understood that various changes, substitutions and alterations can be made herein without departing from the spirit and scope of this disclosure as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A polyolefin-based composition comprising:
(A) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius; and
(B) a first nucleator composition made from or containing a salt of 4-(4-chlorobenzoyl amino) benzoate.

2. The polyolefin-based composition of claim 1, wherein the high density polyethylene has a density in the range of about 0.940 grams per cubic centimeter to about 0.965 grams per cubic centimeter.

3. The polyolefin-based composition of claim 1, wherein the high density polyethylene has a melt index greater than or equal to about 20 grams per 10 minutes, measured according to ASTM D 1238, using a piston load of 2.16 kg and at a temperature of 190 degrees Celsius.

4. The polyolefin-based composition of claim 3, wherein the high density polyethylene has a melt index in the range of about 20 to about 65 grams per 10 minutes, measured according to ASTM D 1238, using a piston load of 2.16 kg and at a temperature of 190 degrees Celsius.

5. The polyolefin-based composition of claim 1, wherein the high density polyethylene has a crystallization temperature in the range of about 110 degrees Celsius to about 115 degrees Celsius.

6. The polyolefin-based composition of claim 1, wherein the high density polyethylene is a substantially linear high density polyethylene having a long chain branching index (LCBI) less than or equal to about 0.5.

7. The polyolefin-based composition of claim 6, wherein the high density polyethylene is a substantially linear high density polyethylene further having a melt flow ratio (MFR) less than or equal to about 65.

8. The polyolefin-based composition of claim 1, wherein the high density polyethylene has a crystallization half time greater than or equal to about 3.0 minutes, measured at 119 degrees Celsius and according to ASTM D3418.

9. The polyolefin-based composition of claim 8, wherein the high density polyethylene has a crystallization half time in the range of about 3.0 minutes to about 10 minutes.

10. The polyolefin-based composition of claim 1, wherein the salt of 4-(4-chlorobenzoylamino) benzoate is in an amount from about 500 to about 3000 ppm, based upon the total weight of the polyolefin-based composition.

11. The polyolefin-based composition of claim 10, wherein the salt of 4-(4-chlorobenzoylamino) benzoate is in an amount from about 1000 to about 2000 ppm, based upon the total weight of the polyolefin-based composition.

12. The polyolefin-based composition of claim 1, wherein the salt of 4-(4-chlorobenzoylamino) benzoate is a sodium salt.

13. The polyolefin-based composition of claim 1, further comprising:
(C) a first additive composition comprising an acid scavenger.

14. The polyolefin-based composition of claim 13, wherein the acid scavenger is selected from the group consisting of calcium stearate, zinc stearate, other stearate-containing compounds, and non-ionic acid neutralizers.

15. The polyolefin-based composition of claim 14, wherein the acid scavenger is zinc stearate.

16. An article of manufacture comprising:
(A) a polyolefin-based composition comprising:
(i) a first polymer composition made from or containing a high density polyethylene having a density greater than about 0.940 grams per cubic centimeter and a melt index greater than about 4 grams per 10 minutes, measured according to ASTM D 1238, using a piston load of 2.16 kg and at a temperature of 190 degrees Celsius; and
(ii) a first nucleator composition made from or containing a salt of 4-(4-chlorobenzoylamino) benzoate.

17. The article of manufacture of claim 16, wherein the article has a wall thickness less than or equal to about 125 mils (3.175 mm).

18. The article of manufacture of claim 17, wherein the article has a wall thickness of about 80 mils (2.032 mm) and low temperature brittle failures of less than or equal to about 20 percent, measured according to ASTM D 3763 at a temperature of −40 degrees Celsius and a rate of 2.2 m/s.

19. The article of manufacture of claim 17, wherein the article has a wall thickness of about 40 mils (1.016 mm) and low temperature brittle failures of less than or equal to about 60 percent, measured according to ASTM D 3763 at a temperature of −40 degrees Celsius and a rate of 2.2 m/s.
